(19) United States
(12) Patent Application Publication
(10) Pub. No.: US 2025/0184733 A1
(43) Pub. Date: Jun. 5, 2025

(54) SIM BASED FIDO AUTHENTICATION

(71) Applicant: T-Mobile USA, Inc., Bellevue, WA (US)

(72) Inventors: Zoltan Homorodi, North Bend, WA (US); Nilesh Ranjan, Sammamish, WA (US); Kyeong Hun An, Sammamish, WA (US)

(21) Appl. No.: 18/525,570

(22) Filed: Nov. 30, 2023

(51) Int. Cl. H04W 12/069; H04W 12/041; H04W 12/72

(52) U.S. Cl. CPC H04W 12/069; H04W 12/041; H04W 12/72

(57) ABSTRACT

Systems and techniques for authenticating user sign-on at an online service provider using a subscriber identity module (SIM) based authentication process are discussed herein. A user may request to sign-on an online service provider using a user device. The user device may be requested to provide a response to a challenge sent by the online service provider. The online service provider may interface with an identity provider (IDP) to send the challenge. The challenge may be received at a SIM component associated with the user device. The SIM component may generate a challenge response to the challenge, encrypt the response with a first security key associated with the SIM component, and send the encrypted challenge response to the IDP using the OTA component. The IDP may authenticate the encrypted challenge response using a second security key associated with the IDP.

### BACKGROUND

Accessing a user account of an online service provider generally requires a user to first sign into the account. Typically, the online service provide would require that a user provide a user name and a password or pin (e.g., the single factor sign-on). The online service provider can require, in addition to the user name and password, that the user provide one or more additional factor that is within the user's possession or knowledge such as the user's biometric information, location information from the user device that is being used to access the service provider, that the user answer a challenge question, and/or the like. Typically, the challenge question is provided using a text messaging service (e.g., using short messaging system (SMS)), using an authentication application (e.g., a third-party authentication app on a mobile device), using a physical authentication device (e.g., a key fob), or the like.

However, each of these methods for providing the challenge question has disadvantages. While a text message may be convenient since it can be sent to at least nearly any mobile device, the text message is insecure and may be intercepted in transit. While an authentication app may also be convenient since the app can be installed at least on most smart mobile devices, the authentication app may require that the user create a separate account to use the authentication app, thereby adding additional complications to the sign-on process, and/or require the user to install the app for each device that the user desires to use the authentication app with. For example, when a user switches for their current device to a new device, the user may need to install and sign into the authentication app on the new device before they are able to sign into the online service provider. While a physical authentication device is very secure since a user will need to physically carry it to use it, it forces the user to remember to carry an extra item and risk not being able to sign into the service provider if the physical authentication device is left behind. In addition, a physical authentication device may further have the disadvantage of being required plug into a desktop or a laptop, and therefore would be inaccessible if the user is only carrying a mobile device such as a smartphone.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example computer architecture for using a SIM based sign-on authentication service.

FIG. 2 is a flow diagram illustrating an example process of using the SIM based sign-on authentication service.

FIG. 3 is a flow diagram illustrating an example process of the SIM based sign-on authentication process at a user device.

FIG. 4 is a flow diagram illustrating an example process of the SIM based sign-on authentication process at an identity provider.

FIG. 5 is a flow diagram illustrating an example process of the SIM based sign-on authentication process at an online service provider.

FIG. 6 illustrates an alternative example computer architecture for using the SIM based sign-on authentication service.

FIG. 7 illustrates another alternative example computer architecture for using the SIM based sign-on authentication service.

### DETAILED DESCRIPTION

Systems and techniques for authenticating user sign-on at an online service provider using a subscriber identity module (SIM) based authentication process are discussed herein. In some examples, a user may request to sign-on an online service provider using a user device. In some examples, the online service provider may request that the user device provide a user name and password for authentication. In some examples, the online service provider may, additionally or alternatively, request the user device provide one or more additional factors for authentication. In some examples, the user device may be requested to provide a response to a challenge sent by the online service provider. In some examples, the online service provider may interface with an identity provider (IDP) to send the challenge. In some examples, in addition to interfacing with the identity provider, the process can further include sending the challenge using an over the air (OTA) component to the user device. In some examples, the challenge may be received at a SIM component associated with the user device. In some examples, the SIM component may generate a challenge response to the challenge, encrypt the response with a first security key associated with the SIM component, and send the encrypted challenge response to the IDP using the OTA component. In some examples, the IDP may authenticate the encrypted challenge response using a second security key to decrypt the encrypted challenge response. In some examples, if the encrypted challenge response is decrypted, the IDP can send the challenge response to the service provider, and the service provider can verify that the challenge response corresponds to an expected response or expected answer. In some examples, if the challenge response corresponds to the expected response or expected answer, the service provider can permit the sign-on.

In some examples, the user device may be a mobile device that is configured to use a SIM component. In some examples, the SIM component may be configured to use a physical SIM card (e.g., a standard SIM, a micro SIM, or a nano SIM) or an embedded-SIM (eSIM). In some examples, the physical SIM card may be an integrated circuit card using the universal integrated circuit card (UICC) standard. In some examples, the eSIM may be software that, when installed on an electronic component such as an embedded-UICC (e-UICC), the eSIM would perform all of the functionalities of the physical SIM card. In some examples, the SIM component may include a secure component that is configured to protect against internal and external software and hardware hacks. In some examples, the secure component may also be sandboxed from the rest of the user device, thereby limiting at least write access of the secure component by other software and/or hardware components of the user device.

In some examples, the secure component can include a security key component that is configured to generate and/or store one or more security keys such as the first security key and/or the second security key. In some examples, the first security key may be a private encryption key that is associated with the SIM component and may be used to authenticate and/or identify that data signed with the first security key originates from the SIM component. In such an example, the secure component may prevent the first security key from being accessed by components outside of the secure component. In some examples, the second security key may be a public encryption key that may be sent to and used by a remote computing device or system such as the IDP to authenticate the data that is signed with the first security key and therefore originates from the SIM component. In such examples, the second security key may be mathematically derived from the first security key. Further, in such an example, the first security key and the second security key may contain different values and/or characters and therefore have content that is different from each other. Additionally, in such an example, data that is signed by the first security key may be encrypted by the first security key and may only be decrypted by the second security key. Similarly, in such an example, data that is signed by the second security key may be encrypted by the second security key and may only be decrypted by the first security key. Alternatively, in some examples, the first security key and the second security key may be a same encryption key.

In some examples, when the first security key and the second security key are generated, the security key component may further generate a digital certificate associated with the second security key. In some examples, the digital certificate may include the identity of the SIM component and/or the user device, the internet protocol (IP) address of the SIM component and/or the user device, a copy of the second security key, a duration of time the digital certificate is valid for, an identity of a certificate authority that issued the digital certificate, and/or the like. In some examples, a public key associated with the digital certificate may be sent to the IDP along with the second security key.

In some examples, the secure component may further include an application component. In some examples, the application component may be an applet that is configured to receive the challenge from the IDP and configured to generate the challenge response. In some examples, the application component can interface with other components of the user device to generate the challenge response. As an example, the challenge may be inquiring a location associated with the user device, and the application component may interface with a location component of the user device to generate the challenge response with the location of the user device. As another example, the challenge may be a prompt for a user to confirm the sign-on, a number, word, or phrase for the user to enter, or a question for the user to answer, and the application component may interface with a user interface of the user device to display the challenge to the user and permit the user to use the user interface to generate the challenge response. In some examples, the user device may include a built in and/or default functionality that permits the user interface to display prompts from the SIM component without an installation of another application. In such an example, the challenge may be displayed and interacted with using the prompt.

In some examples, the application component can send the challenge response to the security key component to sign the challenge response by encrypting the challenge response with the first security key to generate the certified challenge response. In some examples, the application component can receive the certified challenge response and send the certified challenge response to the IDP using the OTA component. In some examples, the application component may receive and store the digital certificate and couple the digital certificate to the certified challenge response and send the certified challenge response and the digital certificate to the IDP.

In some examples, the SIM component may further include an operating system (OS) component that enables the functionality of the application component and/or the security key component and/or facilitates the interfacing of the application component and/or the security key component with the other components of the user device and/or remote device(s). In some examples, the security key component can interface with the OS component to send the second security key and/or the digital certificate to the IDP using a networking component of the user device. Similarly, in some examples, the application component can send the certified challenge response using the OS component and the networking component. In some examples, the application component may be located within the OS component. In some examples, the application component may be located at another location separate from the OS component, but the OS component may have read and/or write access to the application component.

In some examples, the IDP may be a remote computing device or system such as a remote server or a remote computer. In some examples, the IDP may be associated with a digital identity verification entity. In some examples, the IDP may include a security key storage component, a security key authentication component, and networking component. In some examples, the security key storage component may be configured to receive and store the second security key. In some examples, the security key storage component may be configured to receive and store the digital certificate. In some examples, the security key authentication component may be configured to receive the certified challenge response and/or the digital certificate that is coupled to the certified challenge response, verify that the digital signature that is coupled with the challenge response is a valid digital signature, authenticate the certified challenge response by attempting to decrypt the certified challenge response with the second security key, and/or the like. In some examples, once the certified challenge response is successfully decrypted and/or digital signature that is coupled to the certified challenge response is verified, the IDP may send the certified challenge response to the service provider. In some examples, the IDP can interface with the user device, the OTA component, and/or the service provider using its network component.

In some examples, the IDP may interfaces with the SIM component using an OTA component. In some examples, the OTA component may be a separate remote computing device from the IDP, user device, and the service provider. In some examples, the OTA component may be configured to modify data in the SIM component without having to reissue at least a portion of the SIM component. In some examples, the SIM component may be configured such that it will only send and accept data from the OTA component, and the IDP may send and receive data using the OTA component for this reason. In some examples, the OTA component may be associated with a cellular carrier and may be configured to only modify data within the SIM component that is associated with that cellular carrier.

In some examples, the service provider may include a user account component, a challenge generation component, a challenge response authentication component, and a networking component. In some examples, the user account component may include information associated with user sign-on such as user name and password. In some examples, the user account component may provide additional sign-on options to supplement and/or replace the user name and/or the password. In such an example, the user can choose to use the SIM component for sign-on. In some examples, when the user chooses to use the SIM component for sign-on, the service provider can interface with the IDP that is associated with the SIM component. In some examples, the service provider may request that the user provide a phone number or another identifying information that is associated with the SIM component, and the service provider may determine the IDP to interface with that is associated with the cellular carrier of the phone number. In some examples, once the IDP is determined, the challenge generation component can generate a challenge that the IDP can provide to the SIM component. In some examples, the challenge may be a location, a simple confirmation, a complex confirmation, or the like. In some examples, the challenge generation component can also generate and provide to the challenge response authentication component an expected response to the challenge. In some examples, the certified challenge response may be verified by the challenge response authentication component based on whether the certified challenge response corresponds to the expected response. If yes, then the user completes the sign-on process and is granted access to the contents and/or services of the service provider.

In some examples, the techniques discussed herein can improve the security of the user device and/or the service provider by providing a more secure sign-on method than using a password. In some examples, the techniques discussed herein can improve ease of use and accessibility as the user will not need to remember a password to log into an online service provider and can log into the online service provider using a mobile device that the user is already carrying and using on a daily basis. In some examples, the techniques discussed herein also provides an advantage for the user that when the user switches to a new daily use mobile device, that new device can be used for online service provider sign-on without requiring installing a separate authentication app on the new device. Additional improvements are discussed throughout this disclosure.

The techniques discussed herein can be implemented in the context of mobile network protocols such as one or more of 3G, 4G, 4G LTE, and/or 5G protocols and a mobile or cellular phone. In some examples, the techniques discussed herein can be implemented on other devices that can use a mobile or cellular connection such as a tablet, a computer, a vehicle, and/or the like. Example implementations are provided below with reference to the following figures.

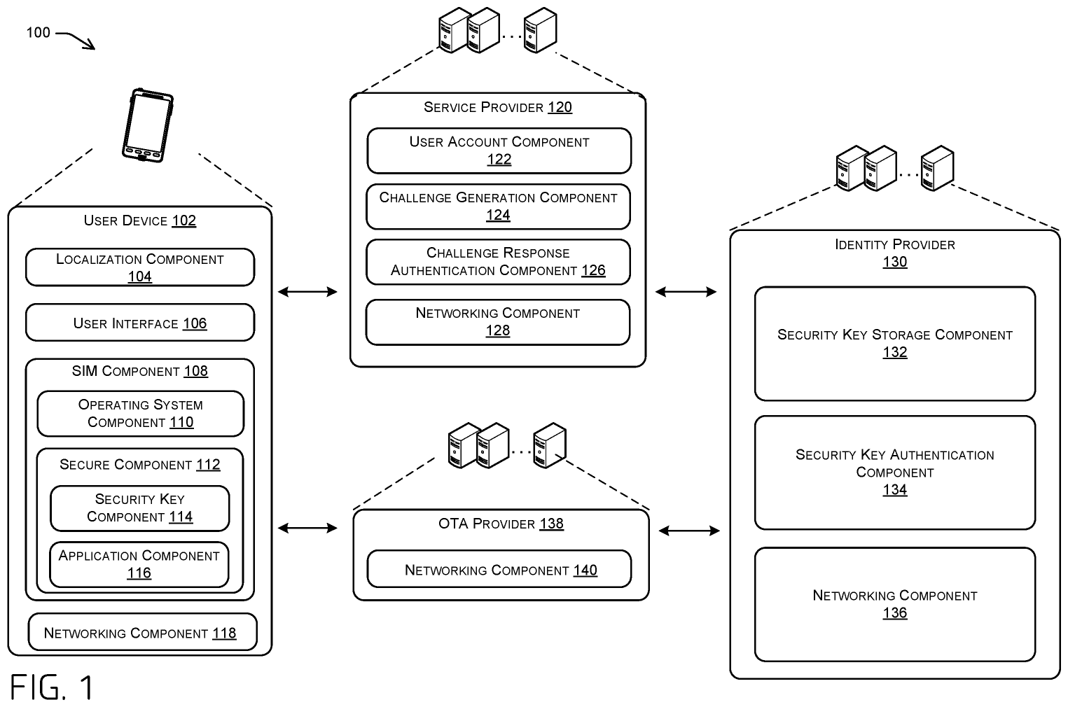

FIG. 1 illustrates an example computer architecture 100 for using a SIM based sign-on authentication service. The example computer architecture 100 includes a user device 102, a service provider 120, an identity provider 130, and an OTA provider 138. In some examples, the service provider 120 may be referred to as a relying party. In some examples, the user device may be a mobile phone that is configured to use a mobile or cellular network such as the 3GPP standard. Alternatively, in some examples, the user device may be a personal computer, a tablet, a vehicle, or any other device that can use a mobile or cellular network. In some examples, the service provider 120 may be an online or Internet/web based platform that requires the user to log in such as an ecommerce platform, a billing platform, or the like. In some examples, the identity provider 130 and the OTA provider may be associated with a mobile or cellular carrier.

The user device 102, as illustrated in FIG. 1, includes a localization component 104, a user interface 106, a SIM component 108, and a networking component 118. In some examples, the localization component 104 may be configured to determine an exact real-time location of the user device (e.g., the type of location used for satellite based map navigation) or an approximate location of the user device (e.g., a city, neighborhood, region, and/or the like). location In some examples, localization component 104 may include hardware such as a receiver or transceiver for a localization service. In some examples, the localization service may be a global navigation satellite system that includes, but is not limited to, Global Positioning System (GPS), Global Navigation Satellite System (GNSS), Galileo, Beidou, and/or the like. In some examples, the localization component 104 may additionally or alternatively include software that is configured to interface with the networking component 118 to determine the location of the user device 102. In such an example, the localization component 104 may determine or receive a location associated with a cellular tower that the networking component 118 is connected to or through positioning based on information associated with a plurality of cellular tower within a first threshold distance of the user device 102. Similarly, in some examples, the localization may determine or receive a location based on information associated with a plurality of wireless access points (e.g., Wi-Fi access points) within a second threshold distance of the user device 102. In some examples, the first threshold distance may be greater than the second threshold distance. In some examples, the location determined from the cellular tower(s) and/or the wireless access points may be an exact location or an approximate location.

In some examples, the user interface 106 may include components that allows the user to interact or interface with the user device 102. Examples of the user interface 106 may include, but are not limited to, one or more displays, one or more touchscreens, a keyboard, a trackpad, a trackball, a mouse, one or more microphones, one or more speakers, one or more physical buttons, one or more haptic buttons, and/or the like. In some examples, the user interface 106 may be used to display a prompt or a notification generated by the SIM component 108 and may be used by the user to interact with the display prompt such as inputting a response based on the displayed prompt or notification.

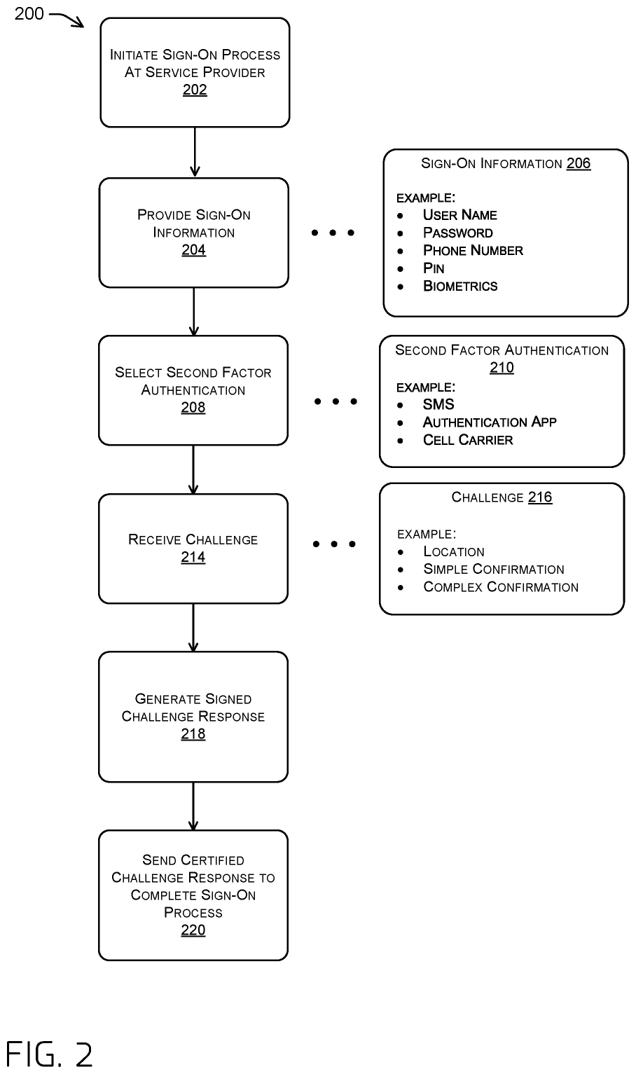

The SIM component 108, as illustrated in FIG. 2, includes an operating system component 110 and a secure component 112. In some examples, the SIM component 108 may be a physical SIM card that includes all of the hardware and software for the operating system component 110 and the secure component 112. In such an example, the SIM component 108 may be removable from the user device 102 and the user device 102 may include hardware that interfaces its components with the SIM component 108. In some examples, the SIM component 108 may be hardware (e.g., an e-UICC) within the user device 102 that is configured to receive or generate and store one or more eSIMs. In such an example, the operating system component 110 may be configured to generate and store an eSIM at a memory component associated with the SIM component 108. In such an example, a portion of the secure component 112 may be partitioned by the operating system component 110 to process and/or store data associated with the eSIM.

The secure component 112, as illustrated in FIG. 1, includes a security key component 114 and an application component 116. In some examples, the secure component 112 may be sandboxed from the other components of user device 102 and/or the SIM component 108, thereby limiting or preventing read and/or write access by the other components of the user device 102 and/or the SIM component 108. In some examples, the secure component 112 may include at least a processor component and a memory component. In some examples, the security key component 114 be located at the memory component and may be configured to use the processor component to generate one or more security keys and be configured store the one or more security keys. In some examples, the security key component 114 can generate and store a first security key and a second security key. In some examples, the first security key and the second security key may be encryption keys associated with asymmetrical encryption. For example, the first security key may be a public key and the second security key may be a public key where the second security key may be generated by being mathematically computed or mathematically derived based on the first security key. In such an example, the first security key may be stored within the security key component where only the security key component would have read and/or write access to the first security key and the second security key may be provided to one or more other parties. In some examples, data encrypted by the first security key may only be decrypted by the first security key or the second security key and the data encrypted by the second security key may only be decrypted by the first security key or the second security key.

In some examples, the first security key and the second security key may be generated as part of a public key infrastructure (PKI). In such an example, the second security key (e.g., the public key) may be packaged into a digital certificate. In some examples, the second security key and identifying data associated with the SIM component 108 may be included in a certificate signing request (CSR). For example, the identifying data may include an integrated circuit card identifier (ICCID) number associated with the SIM component 108, an international mobile subscriber identity (IMSI), and/or the like. In some examples, the digital certificate may be signed by a certificate private key. In some examples, a certificate public key associated with the certificate private key may be provided to the one or more other parties. In some examples, security key component 114 may include a trusted root certificate that is pre-installed at the security key component 114 and the trusted root certificate may use its certificate private key to sign the digital certificate. In such an example, instead of providing the certificate public key to the one or more other parties, the one or more other parties may already have a copy of the trusted root certificate pre-installed. In some examples, the digital certificate may be generated using the X.509 standard.

In some examples, the application component 116 may be software stored at the SIM component 108 that is configured to interface with the identity provider 130, the OTA provider 138 and/or the other components of the user device 102. In some examples, the application component may be an applet. In some examples, while the application component 116 may be positioned within the secure component 112, the application component 116 may be permitted limited outside read and/or write access. For example, the application component 116 may be permitted to receive a challenge that originated from the service provider 120 without first requesting the challenge and may be configured to receive a challenge response corresponding to the challenge from the user interface 106 without first requesting the challenge response. In some examples, if the challenge response is a simple or complex confirmation, when the application component 116 receives the challenge, the application component 116 may use the operating system component 110 to generate a prompt or a notification at the user interface 106 that includes the challenge. In some examples, the prompt or the notification may also include an input for inputting the challenge response. In some examples, if the challenge is for the SIM component 108 to provide a location, the application component may use the operating system component 110 to request location data from the localization component 104. In such an example, the localization data is the challenge response. In some examples, if the challenge is to provide the location, the challenge may be silent to the user and may not provide any prompt or notification to the user. In some examples, the localization component 104 may inform the user, via the user interface, that the application component 116 is requesting location data from the localization component 104 and give the user the option to either permit or deny.

In some examples, once the challenge response is inputted into the prompt or the notification or when the challenge response is generated by the localization component 104, the operating system component 110 can send the challenge response to the application component 116. In some examples, once the challenge response is received by the application component 116, the application component may send the challenge response to the security key component 114 where the challenge response is encrypted by the first security key and coupled with the digital certificate to generate a certified challenge response. After generating the certified challenge response, the security key component 114 can send the certified challenge response back to the application component 116 where the application component 116 may send the certified challenge response using the networking component 118 to the OTA provider 138 which then sends the certified challenge response to the identity provider 130 for authentication.

In some examples, the service provider 120 may be at one or more computing devices such as at one more servers. The service provider 120 includes, as illustrated in FIG. 1, a user account component 122, a challenge generation component 124, a challenge response authentication component 126, and a networking component 128.

In some examples, the user account component 122 may be configured to facilitate user sign-on of the service provider. In some examples, the user account component 122 may include stored sign-on information (e.g., user name(s) and/or password(s)) corresponding to one or more users. In some examples, in response to the user requesting sign-on to the service provider 120, the user account component 122 may request that the user input sign-on information and can determine whether the user provided sign-on information matches the stored sign-on information. In some examples, when the user provided sign-on information is determined to match the stored sign-on information, the user account component 122 may determine that a challenge should be generated by the challenge generation component 124 and sent to the SIM component 108 for further authentication and finalization of the sign-on process. In some examples, user account component 122 may request that the user input a phone number associated with the SIM component 108. In some examples, the user account component 122 may determine a mobile or cellular carrier from the phone number and determine an identity provider and an OTA provider, both of which are associated with the determined mobile or cellular carrier, to interface with and use to send the challenge. In some examples, the user account component 122 may require the user to select from a plurality of authentication options, and when the user selects to use a mobile or cellular carrier to authenticate or selects the mobile or cellular carrier associated with the SIM component 108 to authenticate, the user account component 122 may request the user input the phone number.

In some examples, the challenge generation component 124 may generate a challenge based on the request from the user account component 122. In some examples, the challenge may be referred to as a request for response. In some examples, the challenge may be a location, a simple confirmation, a complex confirmation, and/or the like. In some examples, the location may be associated with a neighborhood, a village, town, or city, a country, a continent, a latitude, a longitude, and/or the like. In some examples, challenge generation component may generate the location challenge, and the challenge response authentication component 126 may, based on a challenge response associated with the location challenge, that the challenge generation component 124 further generate a simple confirmation challenge or a complex confirmation challenge. As an example, the challenge response authentication component 126 may determine that the challenge response is the United States of America (USA) and in response to the challenge response being USA, the challenge generation component can generate a complex confirmation as the next challenge prior to permitting sign-on. In some examples, the simple confirmation may request that the user respond with an affirmation confirming the sign-on request. In some examples, the complex confirmation may include, but are not limited to, providing a number, word, and/or phrase to the user and requiring the user to re-input the number, word, and/or phrase as the challenge response, asking the user a question and requiring the user to answer the question as the challenge response, and/or the like. In some examples, once the challenge is generated, the challenge may be ultimately sent to the SIM component 108 using the networking component 128.

In some examples, the challenge response authentication component 126 may include one or more expected answers. In some examples, when the challenge generation component 124 generates the challenge, it also generates a corresponding expected answer and sends the expected answer to the challenge response authentication component 126. In some examples, when the challenge response authentication component 126 receives the challenge response using the networking component 128, the challenge response authentication component 126 can determine whether the challenge response corresponds to the expected answer. In some examples, if the challenge response corresponds to the expected answer, the challenge response authentication component 126 can communicate to the user account component 122 that the challenge is passed, and the user account component 122 can, in response, permit user sign-on.

In some examples, the identity provider 130 may be one or more computing device(s) such as one or more servers. In some examples, the identity provider 130 may be associated with a particular mobile or cellular network. In some examples, the identity provider 130 can receive the challenge using networking component 136 and send challenge to the SIM component 108 using the networking component 136 through the OTA provider 138. In some examples, the identity provider 130, as illustrated in FIG. 1, a security key storage component 132, a security key authentication component 134, and the networking component 136. In some examples, the security key storage component 132 may be configured to store the second security key, a public key associated with the digital certificate, the trusted root certificate associated with the digital certificate, and/or the like.

In some examples, the security key authentication component 134 may receive the certified challenge response and/or digital certificate using the networking component 136. In some examples, the security key authentication component may use the certificate public key and/or the trusted root certificate to decrypt the digital certificate. In some examples, when the digital certificate is decrypted, the security key authentication component may further verify that the identifying data corresponds to the SIM component 108 and/or the second security key associated with the digital certificate corresponds to the second security key stored at the security key storage component 132. In some examples, once the data on the digital certificate is verified, the security key authentication component 134 may decrypt the certified challenge response using the second security key. In some examples, if the certified challenge response is successfully decrypted using the second security key, the decrypted challenge response may be sent to service provider 120 using the networking component 136 in order for the decrypted challenge response to be verified by the challenge response authentication component 126.

In some examples, the OTA provider 138 may be one or more computing device(s) such as one or more servers. In some examples, the OTA provider 138 may be associated with the mobile or cellular network associated with the SIM component 108. In some examples, the OTA provider 138 may be configured to modify data in the SIM component 108 without having to reissue at least a portion of the SIM component 108. In some examples, the OTA provider 138 may be configured to encrypt or secure data transmitted between the user device 102, the OTA provider 138, and the identity provider 130. In some examples, due to the more secured nature of transmission associated with the OTA provider 138, the SIM component 108 may be configured to only transmit and/or receive data from the OTA provider 138. In some examples, the OTA provider 138 may be configured to receive the challenge from the identity provider 130 and send the challenge to the application component 116 using the networking component 140. In some examples, the OTA provider 138 may be configured to receive the certified challenge response and/or the digital certificate from the SIM component 108 and send the certified challenge response and/or the digital certificate to the identity provider.

Additional details of the user sign-on process are provided in connection with FIGS. 2-5 and throughout this disclosure.

FIG. 2 is a flow diagram illustrating an example process 200 of using the SIM based sign-on authentication service. In some examples, the example process 200 may be performed the using the user device 102.

At operation 202, the process includes initiating a sign-on process at a service provider. In some examples, the operation 202 can include using the user device 102 to navigate to a website, an online portal, an online platform, and/or the like that's associated with the service provider 120. In some examples, the operation 202 may further include navigating to a webpage, platform, and/or portal associated with the sign-on process.

At operation 204, the process includes providing sign-on information such as sign-on information 206. Examples of the sign-on information 206 may include, but are not limited to, a user name, a password, a phone number, a pin, and/or biometrics. In some examples, the operation 204 may include using the user interface 106 to input the sign-on information. In some examples, the service provider 120 may request the user name and the password. In some examples, the service provider 120 may request the user name and the phone number.

At operation 208, the process includes selecting a second factor authentication, such as second factor authentication 210. Examples of the second factor authentication 210 may include, but are not limited to, using SMS to send the challenge, selecting an authentication app service to perform the second factor authentication, selecting a mobile or cellular carrier associated with SIM component 108 and sending the challenge to the SIM component 108, and/or the like. Additional details with respect to the operation 208 are provided in association with FIG. 1 as well as throughout this disclosure.

At operation 214, the process includes receiving the challenge such as challenge 216. In some examples, the challenge 216 may include, but are not limited to, a location, a simple confirmation, a complex confirmation, and/or the like. In some examples, the operation 214 can include receiving the challenge at the application component 116 and generating, using the localization component 104 or the user interface 106, the challenge response. Additional details with respect to the operation 214 are provided in association with FIG. 1 as well as throughout this disclosure.

At operation 218, the process includes generating a certified challenge response. In some examples, the application component 116 can send the challenge response to the security key component 114. In some examples, the security key component 114 can sign (otherwise referred to as encrypt) the challenge response with the first security key and couple the certified challenge response with the digital certificate to generate the certified challenge response. Additional details with respect to the operation 218 are provided in association with FIG. 1 as well as throughout this disclosure.

At operation 220, the process includes sending the certified challenge response to complete the sign-on process. In some examples, the operation 220 can include sending the certified challenge response to the challenge response authentication component 126 to verify the digital certificate and decrypt the encrypted challenge response to re-acquire the challenge response. In some example, the challenge response may be sent to the challenge response authentication component 126 where the challenge response may be verified to complete the sign-on process. Additional details with respect to the operation 220 are provided in association with FIG. 1 as well as throughout this disclosure.

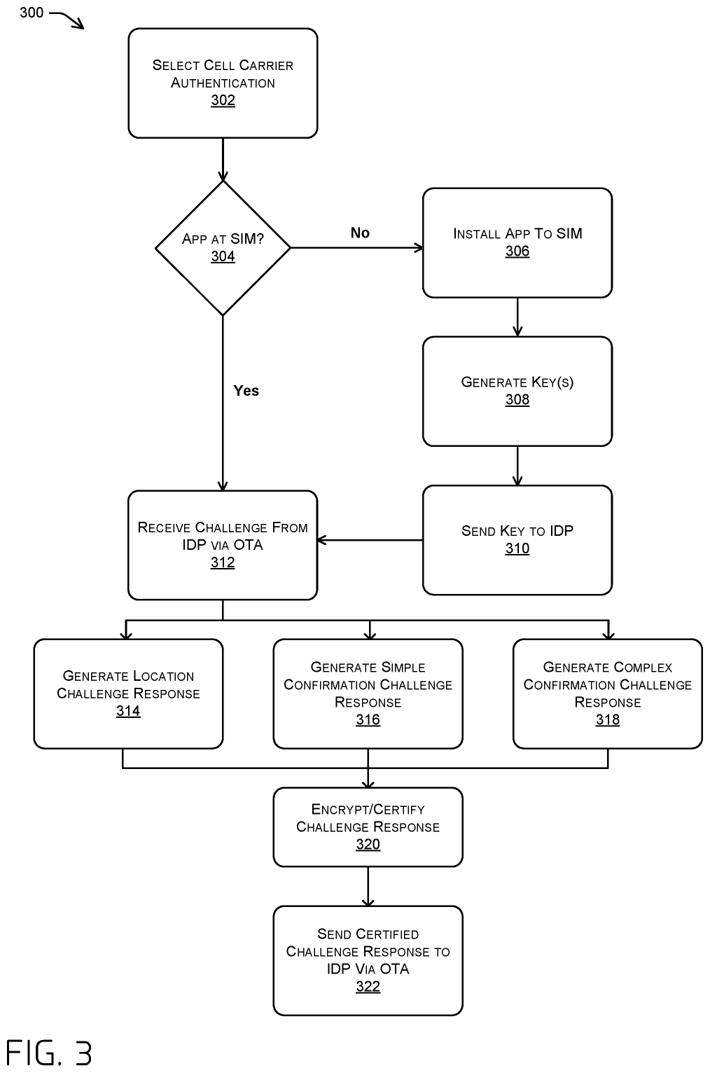

FIG. 3 is a flow diagram illustrating an example process 300 of the SIM based sign-on authentication process at a user device. In some examples, the user device may be the user device 102.

At operation 302, the process includes selecting mobile or cellular carrier authentication. In some examples, the operation 302 may include selecting the mobile or cellular carrier associated with the SIM component 108. In some examples, the operation 302 may include providing a phone number or other identifying data associated with the SIM component 108 and/or the mobile or cellular carrier to the user account component 122. Additional details with operation 302 are provided in association with FIG. 1 as well as throughout this disclosure.

At operation 304, the process includes determining whether an application associated with a SIM component is installed at the SIM component. In some examples, the application may be the application component 116. If the application is not installed then the process proceeds to operation 306. If the application is installed, then the process proceeds to operation 312

At operation 306, the process can include installing the application to the SIM component. In some examples, the operation 306 may include requesting to an OTA provider associated with the mobile or cellular network such as the OTA provider 138 to deliver and/or install the application at the SIM component.

At operation 308, the process can include generating security key(s) at the SIM component. In some examples, the operation 308 may be performed at a security key component such as the security key component 114. In some examples, the operation 308 may include generating the first security key and the second security described in association with FIG. 1 as well as throughout this disclosure. In some examples, the first security key may be a private key and the second security key may be a public key that is mathematically computed or mathematically derived from the first security key and therefore, the first security key may have a different value from the second security key. In some examples, the first security key and the second security key may be copies of the same key and thereby sharing the same value. In some examples, the digital certificate associated with at least the second security key may also be generated after generating the first security key and the second security key. Additional details with operation 308 are provided in association with FIG. 1 as well as throughout this disclosure.

Additionally, during the operation 308, the process can further include determining whether the SIM component 108 and/or the identity provider 130 support asymmetrical encryption. If it is determined that the SIM component 108 and/or the identity provider 130 does not support asymmetrical encryption then the first security key and the second security key will be generated as a same key.

At operation 310, the process can include sending the second security key to an identity provider such as the identity provider 130. In some examples, the operation 310 can further include sending a public key associated with the digital certificate to the identity provider. In some examples, the second security key and the public key associated with the digital certification may be store at the security key storage component 132. Additional details with operation 310 are provided in association with FIG. 1 as well as throughout this disclosure.

At operation 312, the process can include receiving a challenge from the identity provider via OTA. In some examples, the OTA may be sent by a OTA provider 138. In some examples, the challenge may be received at the application component 116. Additional details with operation 312 are provided in association with FIG. 1 as well as throughout this disclosure. In some examples, the process may proceed to operation 314, 316, and/or 318.

At operation 314, the operation 314 includes generating a challenge response that is associated with a location of the user device 102. In some examples, the operation 314 may include using the localization component 104 and/or the networking component 118 to generate the challenge response. Additional details with operation 312 are provided in association with FIG. 1 as well as throughout this disclosure.

At operation 316, the process includes generating a challenge response associated with a simple confirmation challenge. In some examples, the operation 316 may include responding to the challenge by confirming the simple confirmation using the user interface 106. Additional details with operation 316 are provided in association with FIG. 1 as well as throughout this disclosure.

At operation 318, the process includes generating a challenge response associated with a complex confirmation challenge. In some examples, the operation 318 may include answer a question associated with the complex confirmation challenge using the user interface 106. Additional details with operation 318 are provided in association with FIG. 1 as well as throughout this disclosure.

At operation 320, the process includes encrypting the challenge response. In some examples, the operation 320 can include encrypting the challenge response using a first security key and coupling a digital certificate to the encrypted challenge response to generate a certified challenge response. Additional details with operation 320 are provided in association with FIG. 1 as well as throughout this disclosure.

At operation 322, the process includes sending the certified challenge response to the identity provider via OTA. Additional details with operation 322 are provided in association with FIG. 1 as well as throughout this disclosure.

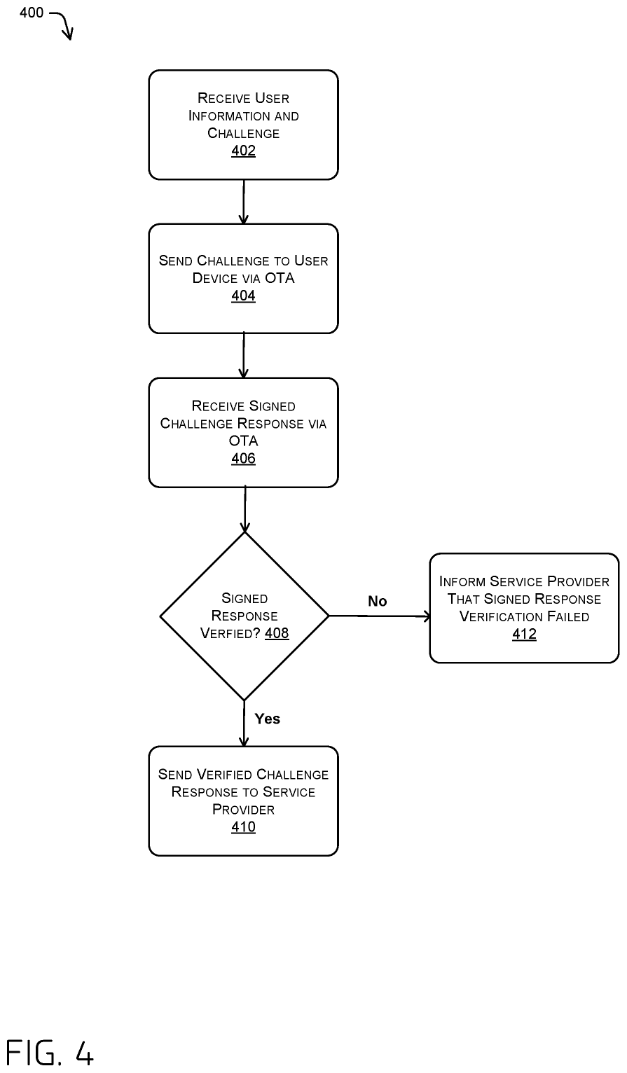

FIG. 4 is a flow diagram illustrating an example process 400 of the SIM based sign-on authentication process at an identity provider. In some examples, the identity provider may be the identity provider 130.

At operation 402, the process includes receiving user information and the challenge. In some examples, the user information may be information such as a phone number or other identifying data that permits the challenge to be sent to the SIM component 108. In some examples, the user information and the challenge may be received from the service provider 120. Additional details with operation 402 are provided in association with FIG. 1 as well as throughout this disclosure.

At operation 404, the process includes sending the challenge to a user device via OTA. In some examples, the user device may be the user device 102. In some examples, the challenge may be sent to the application component 116 via the OTA provider 138. Additional details with operation 404 are provided in association with FIG. 1 as well as throughout this disclosure.

At operation 406, the process includes receiving a signed challenge response via OTA. In some examples, signed challenge response may include the encrypted challenge response encrypted with the first security key and coupled with the digital certificate. Additional details with operation 406 are provided in association with FIG. 1 as well as throughout this disclosure.

At operation 408, the process includes verifying the signed challenge response. In some examples, the operation 408 can include verifying the authenticity of the digital certification and decrypting the encrypted challenge response with the second security key. In some examples, if both are successful, then the process proceeds to operation 410. If one or both fail, then the process proceeds to operation 412. Additional details with operation 408 are provided in association with FIG. 1 as well as throughout this disclosure.

At operation 410, the process includes sending the verified challenge response to the service provider, such as the service provider 120. In some examples, the verified challenge response is the decrypted challenge response. In some examples, the service provider 120 may verify the content of the verified challenge response to finalize the sign-on process. Additional details with operation 410 are provided in association with FIG. 1 as well as throughout this disclosure.

At operation 412, the process includes informing the service provider that the signed challenge response verification failed. In some examples, the service provider 120 may be informed of the failure when either the authenticity of the digital certificate could not be verified or the encrypted challenge response could not be decrypted by the second security key. In some examples, the service provider 120 may be informed why the signed challenge response verification failed. In some examples, the service provider 120 may generate a notification to inform the user that the sign-on process failed and/or could not be completed. In some examples, the notification may further detail the signed challenge response verification failed and why the failure happened. In some examples, in response to the operation 412, the operations digital certificate, the first security key, and the second security may be canceled and/or deleted at the user device 102, and the operation 308 may be performed to generate new keys and a new digital certificate.

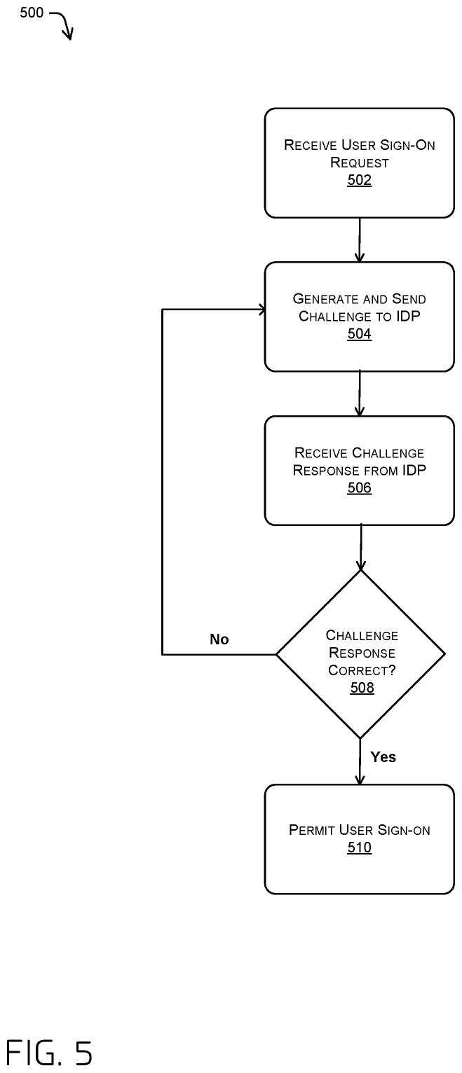

FIG. 5 is a flow diagram illustrating an example process 500 of the SIM based sign-on authentication process at an online service provider. In some examples, the online service provider may be the service provider 120.

At operation 502, the process includes receiving user sign-on request. In some examples, the user sign-on request may be received when the user inputs user information such as a user name, a password, a phone number, and/or the like. In some examples, the sign-on request may be received when the user navigates a sign-on page. Additional details with operation 502 are provided in association with FIG. 1 as well as throughout this disclosure.

At operation 504, the process includes generating and sending the challenge to the identity provider. In some examples, the operation 504 can include generating an expected answer corresponding to the challenge. Additional details with operation 504 are provided in association with FIG. 1 as well as throughout this disclosure.

At operation 506, the process can include receiving a challenge response from the identity provider. In some examples the challenge response may be the decrypted challenge response that is decrypted by the identity provider 130 using the second security key. Additional details with operation 506 are provided in association with FIG. 1 as well as throughout this disclosure.

At operation 508, the process can include determining that the challenge response corresponds to the expected answer. In some examples, if the challenge is associated with a location, the operation 508 can include determining that the location provided with the challenge response corresponds with a location associated with the expected answer. In some examples, if the challenge is associated with confirming a sign-on request, the operation 508 can include verifying that the challenge response included a “confirm” or “yes.” In some examples, if the challenge is associated with answer a question, the operation 508 can include verifying that the content of the challenge response corresponds to the content of the expected answer. In some examples, if the challenge is associated with entering the number, word, and/or phrase displayed in the challenge, the operation 508 can determine whether that number, word, and/or phrase is included in the challenge response.

If the operation 508 passes, then the process continues operation 510 where user is permitted to sign-on the service provider and the sign-on process is terminated because it has been completed. If the operation 508 fails, then the process can return to the operation 504 to generate and send a new challenge. In some examples, the process 400 may be terminated after a threshold number of challenges are generated and sent. In some examples, the operation 508 can further include a notification that the process is terminated and/or the sign-on process failed due to exceeding a threshold number of failed challenges. In some examples, the operation 508 can terminate and include the notification after failing once.

FIGS. 2-5 illustrate example processes and sequence diagrams in accordance with examples of the disclosure. These processes are illustrated as logical flow graphs, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order, omitted, and/or performed in parallel to implement the processes.

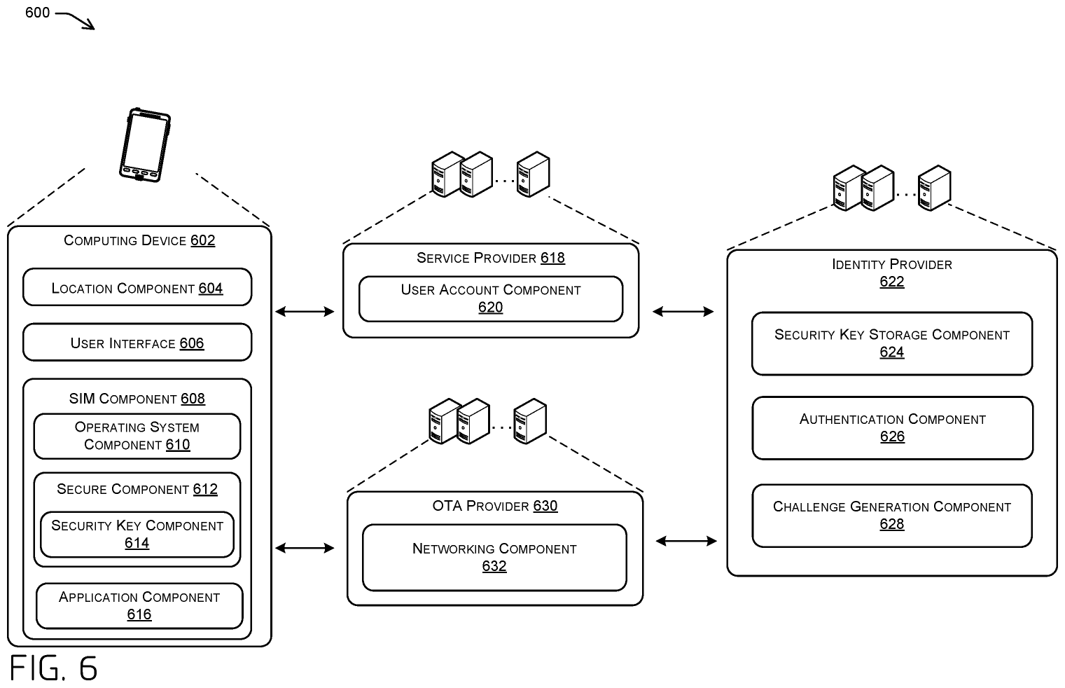

FIG. 6 illustrates an alternative example computer architecture 600 for using the SIM based sign-on authentication service.

In some examples, the computing device 602, the localization component 604, the user interface 606, the SIM component 608, the operating system component 610, the secure component 612, and the security key component 614 may correspond to the user device 102, the localization component 104, the user interface 106, the SIM component 108, the operating system component 110, the secure component 112, and the security key component 114 respectively. The application component 616 is located outside of the secure component 612, but its functionality corresponds to those of the application component 116. In some examples, because the application component 616 is located outside of the secure component 612, it, in the context of eSIMs, can be used for all eSIMs installed at the SIM component 608. In the eSIM context, the application component 116, because it is located within the secure component 112, is only available for use for the eSIM whose secure component partition the application component 116 is located in. In some examples, because the application component 616 is located outside of the secure component 612, the application component 616 may have a more permissive read and/or write access.

In some examples, the service provider 618 and the user account component 620 may correspond to the service provider 120 and the user account component 122 respectively. In some examples, the OTA provider 630 and the networking component 632 may correspond to the OTA provider 138 and the networking component 140 respectively. In some examples, the identity provider 622 and the security key storage component 624 may correspond to the identity provider 130 and the security key storage component 132. The identity provider 622, as illustrated in FIG. 6, further includes a challenge generation component 628. In some examples, the challenge generation component may correspond to the challenge generation component 124. In some examples, the authentication component 626 may combine the functions of the security key authentication component 134 and the challenge response authentication component 126. Therefore, in FIG. 6, the identity provider is responsible for generating the challenge, verifying the digital signature, decrypting the encrypted challenge response, and verifying the accuracy of the content of challenge response. In some examples, once identity provider 622 verifies the accuracy of the content of the challenge response, the identity provider 622 can inform the user account component 620 to permit the user sign-on.

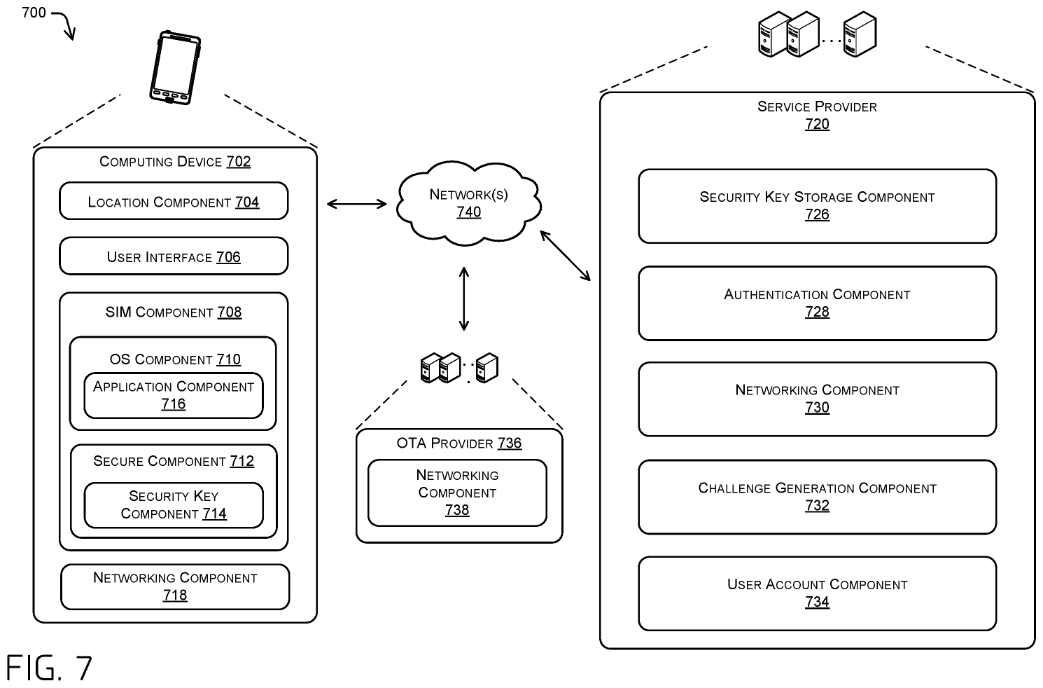

FIG. 7 illustrates another alternative example computer architecture 700 for using the SIM based sign-on authentication service.

In some examples, the computing device 702, the localization component 704, the user interface 706, the SIM component 708, the operating system component 710, the secure component 712, the security key component 714, the application component 716, and the networking component 718 may correspond to the user device 102, the localization component 104, the user interface 106, the SIM component 108, the operating system component 110, the secure component 112, and the security key component 114, the application component 116 and the networking component 118 respectively. In FIG. 7, the application component 616 is located within the operating system component 710

In some examples, the service provider 720 may correspond to the service provider 120. In FIG. 7, the service provider also performs the functions of an identity provider. Therefore, the service provider 720 includes a security key storage component 726, an authentication component 728, a networking component 730, a challenge generation component 732, and a user account component 734. In some examples the security key storage component 726, the authentication component 728, the networking component 730, the challenge generation component 732, and the user account component 734 may correspond to the security key storage component 624, the authentication component 626, the challenge generation component 628, and user account component 620. In some examples, the OTA provider 736 and the networking component 738 may correspond to the OTA provider 138 and the networking component 140 respectively. The computing device 702, the service provider 720 and the OTA provider 736 may communicate with each other through the network(s) 740. Additional details with FIG. 7 are provided in association with FIGS. 1 and 2 as well as throughout this disclosure.

### CONCLUSION

Although the subject matter has been described in language specific to structural features and/or methodological acts, it is to be understood that the subject matter is not necessarily limited to the specific features or acts described above. Rather, the specific features and acts described above are disclosed as example embodiments.

While one or more examples of the techniques described herein have been described, various alterations, additions, permutations and equivalents thereof are included within the scope of the techniques described herein. For instance, systems and techniques described in FIGS. 1-7 can be combined in various ways.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A system comprising:
one or more processors; and
one or more non-transitory computer-readable media storing computer-executable instructions that, when executed by the one or more processors, cause the system to perform operations comprising:
receiving, from a first remote computing device, a sign-on request;
sending, in response to the sign-on request and using a user interface, sign-on information;
receiving, at an application associated with a subscriber identity module (SIM) component, a request for response from a second remote computing device;
determining a type associated with the request for response;
generating, based on the type associated with the request for response and at the application, a response to the request for response;
sending, to a secure component associated with the SIM component, the response; and
encrypting, using a security key at the secure component, the response to generate an encrypted response.

2. The system of claim 1, the operations further comprising:
coupling, at the secure component, the encrypted response to a certificate to generate a signed response; and
sending the signed response to the second remote computing device.

3. The system of claim 1, wherein the security key is a first security key, the operations further comprising:
determining, in response to the sign-on request, that the application is not installed at the SIM component;
installing, based on the application not being installed, the application to the SIM component;
generating, based on installing the application to the SIM component and at the secure component, the first security key and a second security key, the second security key being mathematically computed or derived from the first security key and is different from the first security key;
generating, at the secure component, a certificate associated with the second security key; and
sending at least one of the second security key, the certificate, or a third security key associated with the certificate to the second remote computing device.

4. The system of claim 1, wherein the type associated with the request for response is a location, the operations further comprising:
determining, using a localization component, location data associated with the SIM component; and
generating the response, wherein the response comprises the location data.

5. The system of claim 1, wherein the type associated with the request for response is a confirmation, the operations further comprising:
generating, using a user interface, a prompt associated with the confirmation;
receiving, at the user interface, an answer associated with the confirmation; and
generating the response, wherein the response comprises the answer.

6. A method comprising:
receiving, at an application associated with an integrated circuit component, a request for response from a remote computing device, the request being associated with a sign-on process;
generating a response to the request for response;
sending, to a secure component associated with the integrated circuit component, the response; and
encrypting, at the secure component, the response to generate an encrypted response.

7. The method of claim 6, further comprising sending the encrypted response to a remote computing device.

8. The method of claim 6, further comprising:
coupling, at the secure component, the encrypted response with a certificate to generate a signed response; and
sending the signed response to the remote computing device.

9. The method of claim 6, further comprising:
determining a type associated with the request for response, wherein the type comprises a location or a confirmation.

10. The method of claim 9, wherein the type is a location, the method further comprising:
determining, by a localization component associated with the integrated circuit component, location data; and
generating the response, wherein the response comprises the location data.

11. The method of claim 9, wherein the type is a confirmation, the method further comprising:
generating, using a user interface, a prompt associated with the confirmation;
receiving, at the user interface, an answer associated with the confirmation; and
generating the response, wherein the response comprises the answer.

12. The method of claim 6, further comprising:
determining that the application is not installed at the integrated circuit component; and
installing, based on the application not being installed at the integrated circuit component, the application to the integrated circuit component.

13. The method of claim 6, further comprising:
generating, at the secure component, a first security key and a second security key, the second security key being mathematically computed or derived from the first security key and is different from the first security key,
wherein the first security key is configured to encrypt the response and second security key is configured to decrypt the response encrypted by the first security key; and
sending the second security key to the remote computing device.

14. The method of claim 13, further comprising:
generating, at the secure component, a certificate associated with the second security key; and
sending the certificate or a third security key associated with the certificate to the second remote computing device.

15. One or more non-transitory computer-readable media storing instructions executable by one or more processors, wherein the instructions, when executed, cause the one or more processors to perform operations comprising:
receiving, at an application associated with an integrated circuit component, a request for response from a remote computing device, the request being associated with a sign-on process;
generating a response to the request for response;
sending, to a secure component associated with the integrated circuit component, the response; and
encrypting, at the secure component, the response to generate an encrypted response.

16. The one or more non-transitory computer-readable media of claim 15, the operations further comprising:
coupling, at the secure component, the encrypted response with a certificate to generate a signed response; and
sending the signed response to the remote computing device.

17. The one or more non-transitory computer-readable media of claim 15, the operations further comprising:
determining a type associated with the request for response, wherein the type comprises a location or a confirmation.

18. The one or more non-transitory computer-readable media of claim 18, wherein the type is a location, the operations further comprising:
determining, by a localization component associated with the integrated circuit component, location data; and
generating the response, wherein the response comprises the location data.

19. The one or more non-transitory computer-readable media of claim 15, the operations further comprising:
generating, at the secure component, a first security key and a second security key, the second security key being mathematically computed or derived from the first security key and is different from the first security key,
wherein the first security key is configured to encrypt the response and second security key is configured to decrypt the response encrypted by the first security key; and
sending the second security key to the remote computing device.

20. The one or more non-transitory computer-readable media of claim 19, the operations further comprising:
generating, at the secure component, a certificate associated with the second security key; and
sending the certificate or a third security key associated with the certificate to the second remote computing device.
